(19) United States
(12) Patent Application Publication
(10) Pub. No.: US 2016/0029849 A1
(43) Pub. Date: Feb. 4, 2016

(54) COMBINATION FOOD CONTAINER

(71) Applicant: William Hartley, San Francisco, CA (US)

(72) Inventor: William Hartley, San Francisco, CA (US)

(21) Appl. No.: 14/819,357

(22) Filed: Aug. 5, 2015

Related U.S. Application Data
(63) Continuation-in-part of application No. 29/471,475, filed on Oct. 31, 2013, now Pat. No. D736037.

(51) Int. Cl. A47J 47/08; B65B 17/02; B65B 7/02

(52) U.S. Cl. CPC A47J 47/08; B65B 7/02; B65B 17/02

(57) ABSTRACT

A food container which includes a bottle with a generally cylindrical body, a generally arcuate neck and an elongated pouch which can be formed into a donut-like shape to fit onto the bottle neck. Before it is filled, the elongated pouch is preferably formed in a generally rectangular shape of a light, clear plastic which is sealed at one end and open at the other end. Through the open end, the elongated pouch is filled with food. After the elongated pouch is filled, its open end is sealed. The elongated pouch is then formed into a donut-like shape by affixing its respective ends together using, for example, tape. The donut-like shaped pouch is then inserted onto the generally arcuate neck of the bottle which is filled with a different food product.

This non-provisional patent application claims priority under 35 U.S.C. §120 to U.S. Design Patent Application No. 29/471,475 filed Oct. 31, 2013 and entitled “Food Container”, which will issue as U.S. Pat. No. D736,037 on Aug. 11, 2015, the disclosure of which is hereby incorporated by reference in its entirety.

### FIELD OF THE INVENTION

The present invention relates to food containers, particularly containers for multiple types of foods that are mixed before being consumed.

### BACKGROUND OF THE INVENTION

Food containers have become indispensable for delivering food to consumers in a safe, sanitary and reliable manner. Food containers come in many forms and are made of various materials. Metal cans, for example, have been used for many years to preserve and package food, such as fruits and vegetables, for delivery to consumers. Cartons are used to deliver milk. Glass bottles are common for holding wines, beers and other beverages. More recently, plastic containers have become a prevalent way to package food. Plastic containers have an advantage of being relatively lightweight, often see-through and recyclable.

A special problem for food container designers occurs when two or more types of foods need to be delivered together to the consumer but kept separate until the consumer is ready to use them. For example, pizza mixes are often sold in a box with the tomato sauce, dough flour and dried cheese packaged in separate containers within a cardboard box. To prepare the pizza, the consumer will first mix with dough flour with water to form a crust and then add the tomato sauce and cheese on top before baking.

Yogurt parfaits are another example of a food product that are typically sold with component foods separated prior to use. Yogurt parfaits are often made from yogurt, fresh or frozen fruits (e.g., raspberries, strawberries, blueberries etc.) and crunchy materials, such as granola. While the yogurt and fruit portions of the yogurt parfaits are often mixed together before the yogurt parfait is sold, it is important to keep the crunchy materials separated from the yogurt and fruit prior to sale because the crunchy materials will quickly become soggy and unappealing if they are mixed in the yogurt and fruit for long.

Prior to the present invention, a plastic tray to hold the crunchy materials was often placed above the yogurt inside the yogurt parfait container. While the plastic tray was able to separate the crunchy materials from the yogurt prior to use, the plastic tray is less than an ideal solution. For example, it is often difficult to pry the plastic tray away from the remainder of the yogurt parfait container and, in so doing, the crunchy materials often spill out of the plastic tray and make a mess. In other yogurt parfait containers, the crunchy materials are placed in a sealed cup affixed on top of the yogurt container. This sealed cup approach is illustrated in Zomorodi's U.S. Pat. Nos. D672,236; D648,629; D643,286; D643,284 and D643,285. While this sealed cup approach is usually less difficult and messy to work with than the plastic tray, the sealed cup approach is more expensive and complicated to produce. Therefore, what is needed in the art is a combination food container that is both easy to produce and easy to use.

### BRIEF SUMMARY OF THE INVENTION

The present invention provides a food container which, in its preferred form, includes a bottle with a generally cylindrical body, a generally arcuate neck and an elongated pouch which is formed into a donut-like shape to fit onto the bottle neck. Before being filled with food, the preferred elongated pouch is generally rectangular in shape and formed from a light, clear plastic which is sealed at one end and open at the other end. Through the open end, the elongated pouch is filled with a food product, such as granola for a yogurt parfait, until the elongated pouch assumes a generally cylindrical shape. After the elongated pouch is filled, its open end is sealed. The elongated pouch is then formed into a donut-like shape by affixing its respective ends together. An adhesive, such as tape or glue, is preferably used to form the elongated pouch into a donut-like shape. The donut-like shaped pouch is then inserted onto the generally arcuate neck of the bottle, which is preferably filled with a different food product (e.g., yogurt and fruit), to make a finished multi-component food product.

### BRIEF DESCRIPTION OF THE DRAWINGS

FIG. 1 shows a perspective view of the preferred combination food container of the present invention.

FIG. 2 shows a frontal view of the bottle portion of the combination food container of FIG. 1

FIG. 3 shows the preferred elongated pouch after it has been filled with food and sealed.

FIG. 4 shows the food filled elongated pouch of FIG. 3 formed into a donut-like shape prior to insertion onto the generally arcuate neck of the bottle.

### DETAILED DESCRIPTION OF THE INVENTION

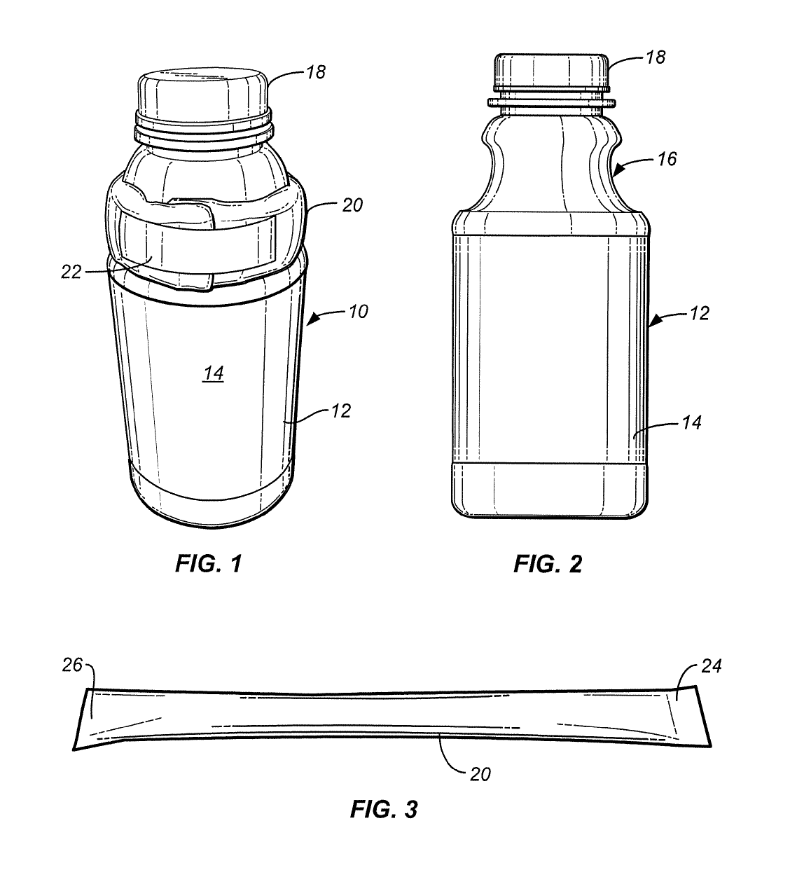

Referring now to FIG. 1, a preferred form of combination food container 10 of the present invention is shown. This combination food container 10 includes a bottle 12 and an elongated pouch 20. As shown in FIG. 2, the bottle 12 preferably consists of a generally cylindrical body 14, a generally arcuate neck 16 and a cap 18. The bottle 12 may be formed from a variety of materials, such as hard plastics, glass or metals, such as aluminum. Once the bottle 12 is filled with food or beverage, the cap 18 is used to seal the bottle to better preserve the food from contamination or spills. The generally arcuate neck 16 of the bottle is shaped to accept and hold the elongated pouch 20. In one preferred embodiment for a single serving yogurt parfait, the bottle 12 has a height of 6 inches and a diameter for its cylindrical body of 2 ½ inches. The bottle 12 in this preferred embodiment is filled with a mixture of yogurt and fruit, such as strawberry, blueberry or peach.

FIG. 3 shows a preferred form of elongated pouch 20 of the present invention before it is formed into the donut-like shape shown in FIG. 1. The elongated pouch 20 is preferably formed from a thin, yet durable, flexible plastic, such as polyethylene, polypropylene, cast polypropylene or cellophane. Before being filled, the preferred pouch 20 of the present invention is in a flat, generally rectangular shape with an open end 24 and a sealed end 26. Through the open end 24, the pouch 20 can be filled with food and, in so doing, the pouch 20 assumes a generally cylindrical shape. After the pouch 20 is filled with food, the open end 24 is sealed to preserve the food from contamination or spills. The open end 24 can be sealed by heat, irradiation or a variety of other means known in the art. Suitable machines to automatically fill and seal elongated pouches 20 are made by Ropak Manufacturing Company, Inc. of Decatur, Alabama. In one preferred embodiment for a single serving yogurt parfait, the elongated pouch 20 is 9 inches long and 1 inch wide. In this embodiment, the elongated pouch 20 is filled with a mixture of toasted oats, chia seeds and almonds.

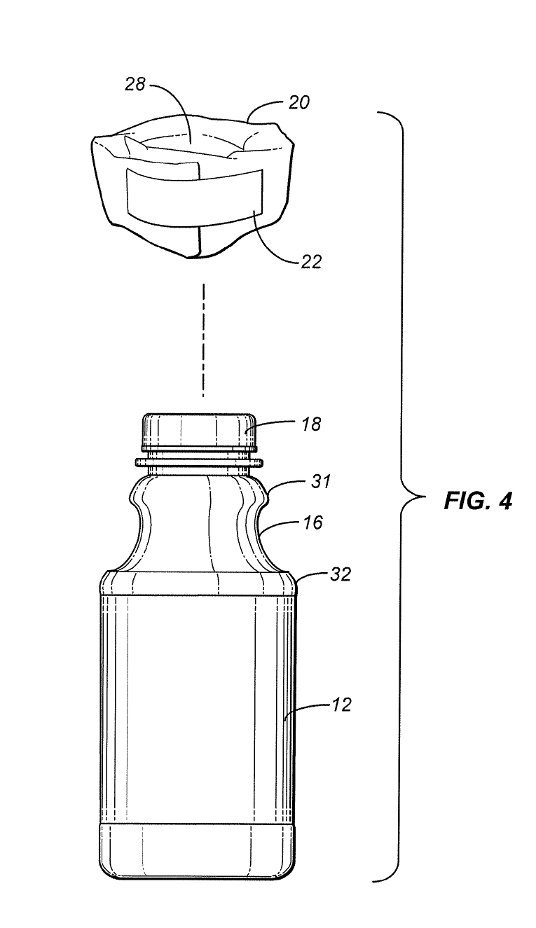

As shown in FIG. 4, after the pouch 20 is filled and sealed, it is preferably formed into a donut-like shape having an annular space 28 which is big enough to slide over the bottle cap 18 and top portion 31 of the generally arcuate bottle neck 16 but not the bottom portion 32 of the generally arcuate bottle neck 16. To form the donut-like shape, the ends 24, 26 of the elongated pouch 20 are affixed together with tape 22, glue or other affixation means known to those in the art. In the preferred embodiment, the tape 22 has an adhesive that is specifically selected for its ability to hold the donut-like shape closed while being easy to remove and not leaving any sticky residue. A suitable tape 22 adhesive is the BC-20™ rubber adhesive sold by Spinnaker Coating, LLC of Troy, Ohio. The size of the tape should be slightly less wide than the pouch 20, so as not to wrinkle the edges of the pouch 20, and should be long enough to secure the pouch 20.

After the elongated pouch 20 is formed into a suitably dimensioned donut-like shape, it is lowered onto the bottle neck 16 until it seats on top of the bottom portion 32 of the bottle neck 16. The shape of the bottle neck 16 is preferably formed so that, when the donut-shaped pouch 20 is placed on the bottle neck 16, the pouch 20 can stay on the bottle neck 16 without adhesives or additional packaging. The internal diameter of the bottle cap 18 and top portion 31 of the generally arcuate bottle neck 16 should be smaller than the diameter of the annular space 28. By comparison, the diameter of the bottom portion 32 of the generally arcuate bottle neck 16 should be larger than the internal diameter of the annular space 28. In one preferred embodiment for a single serving yogurt parfait, the elongated pouch 20, when formed into a donut-like shape, has a diameter for its annular space 28 of 2 inches and an external diameter of 2 ½ inches.

While the bottle neck 16 has been described as having a generally arcuate shape and the filled pouch 20 has been described as having a donut-like shape, these shapes need not be perfectly arcuate and donut-like. The arc of the neck 16 and donut-like elongated pouch 20, for example, could be more squared off and still work. What is important is that the pouch 20 is formed into an enclosure that will fit over the top of the bottle cap 18 as well as the top portion 31 of the bottle neck and then seat at the bottom portion 32 of the bottle neck in a way that it does not fall off. It is with these attributes in mind that the word “generally” is used to describe the arcuate shape and the word “like” is used to describe the donut.

To use the combination food container 10 of the present invention, one simply removes the donut-shaped pouch 20 from the neck 16 of the bottle, disconnects the two ends 24, 26 of the pouch (e.g., by removing the tape 22), tears open one end of the pouch 20 and then, as desired, combines the food contents of the pouch 20 with the food contents of the bottle 12.

In the foregoing specification, the invention has been described with reference to specific preferred embodiments and methods. It will, however, be evident to those of skill in the art that various modifications and changes may be made without departing from the broader spirit and scope of the invention as set forth in the appended claims. For example, rather than using a single pouch, multiple pouches with different food ingredients in them could be stacked on top of one another once the lowest pouch is seated on top of the bottom of the bottle neck. Preferably, the pouches should be stacked no higher than the top of the cap. In the case of a yogurt parfait, an upper pouch could be filled with fresh fruit or flavoring (e.g., vanilla) and a lower pouch could be filled with crunchies (e.g., granola). Those of skill in the art will also recognize that the combined food container of the present invention need not be limited to use with yogurt parfaits. It could also be used, for example, with other food combinations, such as the pizza mix described earlier. The combined food container of the present invention could also be used outside the food industry. For example, one type of epoxy resin could be stored in the bottle and a complementary epoxy resin could be stored in the pouch. For these reasons, the specification and drawings are, accordingly, to be regarded in an illustrative, rather than restrictive sense; the invention being limited only by the appended claims.

What is claimed is:

1. A combined container comprising:
a bottle with a body, a cap and a generally arcuate neck, wherein said generally arcuate neck has a smaller top portion and a larger bottom portion;
an elongated pouch which assumes a generally cylindrical shape when it is filled with material;
wherein, after it is filled, said elongated pouch is formed into a donut-like shape having an annular space which allows said donut-like elongated pouch to fit over the smaller top portion of said generally arcuate bottle neck and seat onto the larger bottom portion of said generally arcuate bottle neck.

2. The combined container of claim 1 wherein said elongated pouch has a flat, generally rectangular shape with two ends before being filled with material and formed into a donut-like shape.

3. The combined container of claim 2 wherein said filled elongated pouch is formed into a donut-like shape by affixing its two ends together.

4. The combined container of claim 3 wherein said two elongated pouch ends are affixed together using tape.

5. The combined container of claim 4 wherein said tape has a rubber adhesive that is selected for its ability to hold the donut-like elongated pouch closed while allowing the tape to be easy to remove and not leaving any sticky residue.

6. The combined container of claim 1 wherein the body of said bottle is formed in a generally cylindrical shape.

7. The combined container of claim 1 wherein said bottle and said elongated pouch are filled with different types of food.

8. The combined container of claim 7 wherein said bottle is filled with yogurt and said pouch is filled with granola.

9. The combined container of claim 1 wherein said bottle is made from hard plastic, glass or metal.

10. The combined container of claim 1 wherein said elongated pouch is made from a flexible plastic, such as polyethylene, polypropylene, cast polypropylene or cellophane.

11. A method of manufacturing a combined food product comprising the steps of:
placing a first type of food into a bottle having a generally arcuate neck, wherein said neck has a smaller top portion and a larger bottom portion;
placing a second type of food into an elongated, generally rectangular pouch which is sealed at one end and open at the other end;
sealing the open end of the elongated pouch after it has been filled with said second type of food;
affixing the ends of said elongated pouch together to form a donut-like shape;
placing said donut-like shaped elongated pouch over the smaller top portion of said bottle neck until said elongated pouch seats onto the larger bottom portion of said bottle neck.

12. The method of claim 11 wherein the ends of said elongated pouch are affixed together with tape.

13. The method of claim 11 wherein said first type of food includes yogurt.

14. The method of claim 11 wherein said first type of food is a mixture of yogurt and fruit.

15. The method of claim 11 wherein said second type of food is a mixture of toasted oats, chia seeds and almonds.
